(19) United States
(12) Patent Application Publication
(10) Pub. No.: US 2011/0129588 A1
(43) Pub. Date: Jun. 2, 2011

(54) PROCESS FOR PREPARATION OF A GELATINOUS FOOD PRODUCT CONTAINING ALCOHOL

(75) Inventor: Matthew Alexander Marini, Royal Oak, MI (US)

(73) Assignee: METROPOLIS INDUSTRIES, LLC, Southfield, MI (US)

(21) Appl. No.: 12/793,395

(22) Filed: Jun. 3, 2010

Related U.S. Application Data
(60) Provisional application No. 61/264,914, filed on Nov. 30, 2009.

(51) Int. Cl. A23L 1/0532; A23L 1/05

(52) U.S. Cl. 426/575; 426/573

(57) ABSTRACT

A ready to eat gelatin containing alcohol that may be stored on a shelf indefinitely without refrigeration is made possible by the preparation of an at least partially hydrated gelatin blend and mixing spirits with the gelatin blend. Additional ingredients in either liquid or dry form may be added at the time the spirits are added. The solution is immediately dispensed into containers and sealed to prevent the alcohol from evaporating. The mixture is flash cooled in the container to form a gelatin having an indefinite shelf life without refrigeration.

### CROSS-REFERENCE TO RELATED APPLICATIONS

This application claims the benefit of and priority to prior filed co-pending provisional application Ser. No. 61/264,914, filed Nov. 30, 2009, the disclosure of which is incorporated herein by reference.

### FIELD OF THE INVENTION

The present invention relates to a process for the preparation of a gelatinous food product. More specifically, the present invention relates to a process for preparation of a gelatinous food product containing alcohol.

### BACKGROUND OF THE INVENTION

As used herein, the term “gelatinous” shall refer to a product that resembles a product containing gelatin, rather than a product specifically containing gelatin—a common jellying agent. When gelatin is used in the preparation of a ready-to-eat jellied food products (as opposed to a powdered, gelatin-containing mix which a consumer dissolves in water) one of the initial steps in the process has been to dissolve the gelatin in hot water and then to quickly utilize the solution in the preparation of a product, typically a refrigerated or frozen product. It is known to be undesirable to leave prepared gelatin products unrefrigerated because the food product will spoil.

Gelatin is a protein derived from collagen, the connective tissue of animals. Gelatin is a protein with unique gelling properties. As gelatin is heated it becomes soluble, and forms a protein matrix that traps water within it. Gelatin is a widely used food ingredient and has been used to modify the texture of food product such as desserts, ice cream and frozen confections.

Gelatin is a type of hydrocolloid—a long chain of complex sugars called polysaccharides. A hydrocolloid is defined as a type of mechanical mixture where one substance is dispersed evenly throughout water. A hydrocolloid has colloid particles that spread throughout water, and depending on the quantity of water available, can behave as a gel or liquid. Many hydrocolloids can change their physical behavior and characteristics with the addition or elimination of heat. Hydrocolloids have the ability to thicken and form gels at very low concentrations.

A popular food product prepared by mixing liquor with powdered, gelatin-containing mix, are commonly referred to as “Jell-O Shots”. In such products, the “Jell-O Shot” is prepared by mixing the gelatin-containing mix with boiling water, then adding liquor (an alcoholic beverage containing ethanol) and cooling the resultant mixture to solidify the product.

However, the “Jell-O Shots” prepared according to conventional methods often produce inconsistent and undesirable results. For example, the final product can separate, where liquid contained within the jellying agent separates from the jellying agent. Spoilage is also an issue. Products manufactured according to this method also spoil within days. Therefore, it is important that the product have a demonstrable shelf life, and more so, that the product be stored as long as a year without refrigeration if the product is going to be made commercially available to the public. There is a considerable expense in maintaining a product in a refrigerated state for a long period of time. In addition, to be commercially desirable, the product should have consistent transparency.

All of the aforementioned concerns must be solved to provide a commercially available “Jell-O Shot”. Therefore, there is a need to provide a gelatinous food product containing alcohol that has a demonstrable shelf life without refrigeration. In addition, there is a need to provide a process for producing a gelatinous food product containing alcohol that doesn't separate and has consistent transparency.

### SUMMARY OF THE INVENTION

A process for preparing a gelatinous food product containing alcohol comprises providing water heated to between about 185 degrees Fahrenheit and 212 degrees Fahrenheit. The heated water is mixed with agar to about a 30:1 weight ratio to form an at least partially hydrated blend. The blend is mixed until the agar is dissolved. Spirits are mixed with the blend to about a 0.475:1 weight ratio to form a solution containing alcohol. The solution is immediately dispensed into a polypropylene lined cup. Once the solution is dispensed into the cup, a foil seal is attached to the rim .of the cup using an adhesive to prevent the alcohol from evaporating. The sealed solution is flash cooled to form a gelatin having consistent properties and an indefinite shelf life without refrigeration.

A composition of a gelatinous food product containing alcohol, comprises an at least partially hydrated blend of water mixed with a vegetable based jelling agent of about a 30:1 weight ratio, and spirits mixed with the partially hydrated blend to about a 0.475:1 weight ratio. Additional ingredients may be added to the blend include liquid or powdered flavoring, sweetener, and coloring. The addition of flavoring to blend is about a 0.06:1 weight ratio.

Further objects, features and advantages of the present invention will become apparent to those skilled in the art from analysis of the following written description.

### BRIEF DESCRIPTION OF THE DRAWINGS

FIG. 1 is a perspective view of the alcohol infused gelatinous food product according to the principles of the present invention.

### DESCRIPTION OF THE PREFERRED EMBODIMENT

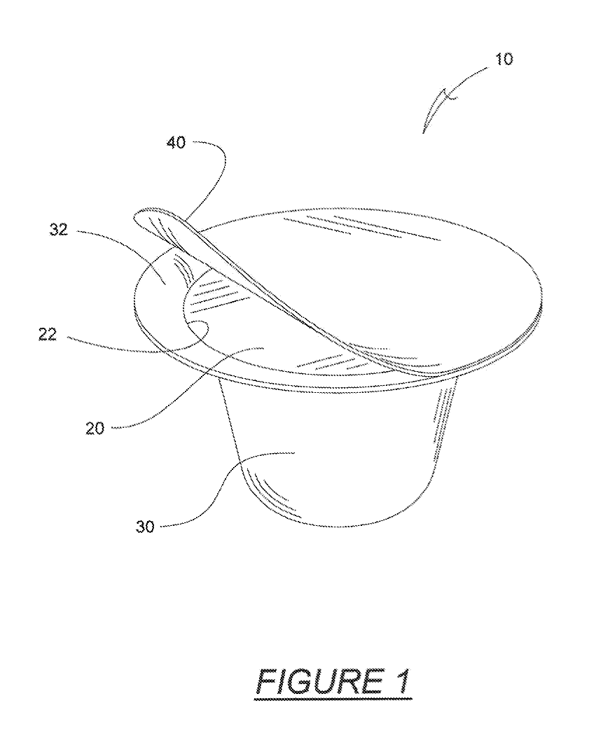

The present invention provides a composition and method of preparing a gelatinous food product containing alcohol. Referring now to FIG. 1, a perspective view of an alcohol infused gelatinous food product 10 according to the principles of the present invention is shown. The product 10 comprises a solution 20 filled to a fill level 22 in a container 30. In the preferred embodiment, the container 30 is a. polypropylene lined cup. In the preferred embodiment the container 30 includes a rim 32 providing a surface for application of an adhesive (not shown). A lid 40, preferable foil, is secured to the rim 32 .of the container 30 to provide a seal and secure the solution 20 within the container 30.

As used herein, the ingredient in a gelatinous food product that solidifies the mixture is a jelling agent. Examples of vegetable based jelling agents include agar, pectin, guar gum, locust bean gum, xanthan gum, gum acacia, carrageenan, chemically modified food starch, and chemically modified pectins. The jellying agent in the present invention is vegetable based and in the preferred embodiment of the present invention, the jellying agent is selected from the group consisting of carrageenan and agar. Both carrageenan and agar are made from seaweed. Some varieties of agar are reversible, that is, they are capable of absorbing water when heated, cooled, reheated and reliquefying, and then cooled again. Non reversible agar does not reliquefy.

The process begins by providing water heated to between about 185 degrees Fahrenheit and 212 degrees Fahrenheit. The heated water is mixed with a vegetable based jellying agent to about a 30:1 weight ratio to form an at least partially hydrated blend. The jellying agent is preferably carrageenan in a powdered form. In addition, Agar has been shown to demonstrate very good resistance to microbial proliferation. The blend is mixed until the jellying agent is dissolved. It is essential that the solid contents of the jellying agent be thoroughly dissolved in the water. The jellying agent determines how much water can be absorbed and the consistency of the final food product. If the solids do not dissolve or the percentage of the solids is too high, the product does not properly gelatinize. Once the solids are broken down, the flavoring, sweetener, coloring and spirits are added and combined in a high-speed mixer.

Spirits are mixed with the at least partially hydrated blend to about a 0.475:1 weight ratio to form a solution containing alcohol. As used herein, spirits refers to beverages containing ethanol, also commonly known as liquor, and preferably a neutral grain spirits, such as vodka. In the preferred embodiment, the spirits is an 80 proof (40% ethanol by volume) vodka. Although vodka is the preferred spirits, other substitutes may be employed, including, but not limited to, tequila, rum, amaretto, rum, or schnapps. In the present embodiment, the target alcohol percentage by volume is 12%.

Not wishing to be bound by theory, it is believed that the process of partially hydrating the agar enables the mixture to absorb the spirits to yield an acceptable alcohol concentration while exhibiting an indefinite shelf life without refrigeration.

The flavoring may comprise fruit juice or artificial flavoring. The sweetener may comprise a combination of sugar and flavored high fructose corn syrup. Additional ingredients may include citric acid. Citric acid increases the tartness and influences the stability of the gelled product. The addition of citric acid will decrease the ph of the solution. Gelatinous products ideally have a pH between 5 and 7. Higher concentrations of citric acid resulting in a pH of below 5 has been shown to produce a cloudy gelatinous product. Additional ingredients in either liquid or dry form may be added during this step and prior to cooling.

After the spirits and sweeteners, flavoring and colorings are added to the solution, the solution is immediately dispensed and sealed to prevent alcohol from evaporating. In the preferred embodiment, the solution 20 is dispensed in into cups 30 and sealed with a foil lid 40. The foil lid 40 is preferably attached to the rim 32 of the cup 30 with an adhesive disposed between the lid 40 and rim 32 of the cup. Although other substitutes may be employed, in the preferred embodiment, the cup is a polypropylene lined cup.

The sealed solution 20 is flash cooled to “set” at the desired final product consistency, which occurs between 90 degrees Fahrenheit and 104 degrees Fahrenheit. The flash cooling process freezes the solution 20 to create a tightly bonded matrix of the jellying agent, water and ethanol. The process forms a gelatinous food product 10 having consistent properties and an indefinite shelf life without refrigeration. The gelatinous food product 10 exhibits excellent resistance to separation when exposed to temperature variation.

The gelatinous product of the present invention is made from a plant-based gelatin which does not require refrigeration to maintain its gelatin form. The product is considered “vegetarian” as it does not contain animal products. The benefit of not requiring refrigeration opens this product to a broad market and may be sold in the non-refrigerated section of retail stores. This is also a benefit for bar and nightclub businesses where refrigeration space is limited. Traditionally, this was a product developed by the consumer and now the consumer no longer needs to produce these products themselves.

In usage, the consumer peels back the foil top 40 and gently squeezes the sides of the cup 30, dispensing the gelatinous product 10 from the cup 30 in a single, cohesive material. The product exhibits excellent cohesive properties—the consumer sucks the entire product out of the cup in their first attempt; there is no need to dig their tongue and fingers into the product cup to retrieve all of the gelatinous product of the present invention.

### EXAMPLE 1

Production of a 40 gram product to create a semi-solid edible “jelly type” product with about a 12% alcohol content by volume.

Water is heated to between about 185 degrees Fahrenheit and 212 degrees Fahrenheit. 24.4 grams of heated water is combined with 0.8417 grams of a vegetable based jellying agent made from seaweed, commonly referred to as carrageenan. The water-carrageenan blend is mixed until all of the solids are dissolved. The weight ratio of the water to carrageenan is about a 30:1. The 30:1 ratio forms an at least partially hydrated blend. Once the solids are broken down, the flavoring, sweetener, coloring and spirits are added and combined in a high-speed mixer.

12 grams of a neutral grained alcohol, specifically 80 proof vodka (40% alcohol by volume), is mixed into the partially hydrated blend. When dispensed, this will yield about 12% alcohol by volume. A combination sweetener/flavoring of 2.2575 grams is also added to the mixture at this point. The sweetener/flavoring comprises high fructose corn syrup and sugar. The addition of sweetener/flavoring to the solution containing alcohol yields a solution having a flavoring to solution weight ratio of about 0.06:1. At this point, 0.4208 grams of citric acid is added to the solution. The solution is hot poured into a plurality of polypropylene lined cups and immediately sealed with a foil and adhesive and flash cooled by immersing the solution into an ice bath.

The end product yield is a jellied food product having about 12% alcohol by volume.

### EXAMPLE 2

Production of about a 35 gram product to create a semi-solid edible “jelly type” product with about a 12% alcohol content by volume. About 65% water, 12.6% alcohol mixture of 95% ethanol and 12.5% sugar, 8% fructose and .55% carrageenan are provided. Additional ingredients include citric acid 0.375%, malic acid 0.375% and flavorings and colorings. The materials are weighed and provided. The water is mixed with the carrageenan and the mixture is heated until between about 75 degrees Celsius to 79 degrees Celsius to form a partially hydrated blend. The sugar, fructose and acids are added to the mixture. Next the colorings, flavorings and alcohol is added to the blend. The target pH is 3.5+/−0.2 and target Brix is 25+/−2. Brix is a measurement of sugar in an aqueous solution. The containers and filled with the final solution and sealed. The product is then heated to above 85 degrees Celsius to sterilize the mixture and then cooled to form a jellied food product having about 12% alcohol by volume. The product may then be stored at room temperature for up to a year.

The foregoing discussion discloses and describes the preferred structure and control system for the present invention. However, one skilled in the art will readily recognize from such discussion, that various changes, modifications and variations can be made therein without departing from the true spirit and fair scope of the invention.

What is claimed is:

1. A process for preparing a gelatinous food product containing⁻alcohol comprises:
providing water heated to between about 185 degrees Fahrenheit and 212 degrees Fahrenheit;
mixing the heated water with a jelling agent to about a 30:1 weight ratio to form an at least partially hydrated blend;
continuing to mix the blend is until the jelling agent is dissolved;
introducing spirits to the blend to about a 0.475:1 weight ratio to form a solution containing alcohol;
dispensing the solution into a container;
sealing the container; and
flash cooling the solution to form a gelatinous product having 12% alcohol by volume.

2. The process for preparing a gelatinous food product containing alcohol of claim 1, wherein, the jelling agent is carrageenan.

3. The process for preparing a gelatinous food product containing alcohol of claim 1, wherein, the jelling agent is agar.

4. A process for preparing a gelatinous food product containing 12% alcohol by volume comprises:
providing, by volume, about 65% water and 0.55% jelling agent;
mixing the water and jelling agent;
heating the water and jelling agent to between about 75 degrees Celsius and 79 degrees Celsius to form an at least partially hydrated blend;
providing, by volume, about 12.5% sugar, 8% fructose and 0.375 citric acid and 0.375 malic acid;
mixing the sugar, fructose and acid to the at least partially hydrated blend;
providing, by volume, about 12.6% of an alcohol mixture of comprising 95% ethanol;
mixing the alcohol mixture into the at least partially hydrated blend; and
cooling the mixture to form a jellied food product having about 12% alcohol by volume.

5. The process for preparing a gelatinous food product containing 12% alcohol by volume of claim 4, wherein, the jelling agent is carrageenan.

6. The process for preparing a gelatinous food product containing 12% alcohol by volume of claim 4, wherein, the jelling agent is agar.
